(19) United States
(12) Patent Application Publication
(10) Pub. No.: US 2026/0244895 A1
(43) Pub. Date: Aug. 20, 2026

(54) KNOWLEDGE REPRESENTATION LEARNING-BASED FUSION TRAINING FOR RISK CONTROL MODEL

(71) Applicant: Alipay (Hangzhou) Information Technology Co., Ltd., Hangzhou (CN)

(72) Inventors: Jing ZHOU, Hangzhou (CN); Le LV, Hangzhou (CN); Xing FU, Hangzhou (CN); Ningtao WANG, Hangzhou (CN); Xin YANG, Hangzhou (CN); Yang YANG, Hangzhou (CN); Chenzhi JIANG, Hangzhou (CN); Fangqing LIU, Hangzhou (CN); Weiqiang WANG, Hangzhou (CN)

(21) Appl. No.: 18/872,183

(22) PCT Filed: May 19, 2023
(86) PCT No.: PCT/CN2023/095185

§ 371 Date: Dec. 5, 2024

(30) Foreign Application Priority Data
Jun. 20, 2022 (CN) 202210696228.3

(51) Int. Cl. G06N 3/042

(52) U.S. Cl. CPC G06N 3/042

(57) ABSTRACT

The present disclosure provides a fusion training method for a risk control model, including: receiving label data, and refining expert knowledge; separately performing multi-order feature crossing on the label data and the expert knowledge, to obtain a data representation and a rule representation; purifying the data representation based on the rule representation; and training and outputting the risk control model based on the purified data representation.

### TECHNICAL FIELD

The present disclosure mainly relates to knowledge representation learning, and in particular, to knowledge representation learning-based risk control model training.

### BACKGROUND

To avoid transaction event risks, a credible risk control aims to find out risk-free pure white traffic for quick release. Precipitation of trusted data can help release low-risk transaction events and reduce an analysis amount of an identification layer. A conventional risk control trusted model performs trusted model training based on pre-defined black and white samples. Black samples come from handling of payment events complained by users. White samples come from events that the users pay successfully and risk control actions such as complaints, audits, and control are not involved. Compared with a huge quantity of white samples, the black samples are very likely to be insufficient to feed back a full picture of risk events. Insufficient black samples usually lead to insufficient robustness of the risk control trusted model.

Therefore, in the art, an efficient risk control model training method that can improve robustness of a model is needed.

### SUMMARY

To resolve the above-mentioned technical problems, the present disclosure provides a knowledge representation learning-based fusion training solution for a risk control model. Based on precipitation of expert experience in the risk control field, and by introducing multi-order feature crossing and data purification, robustness of the risk control model is improved, and interpretation of the risk control model satisfies a requirement.

In one or more embodiments of the present disclosure, a knowledge representation learning-based fusion training method for a risk control model is provided, including: receiving label data, and refining expert knowledge; separately performing multi-order feature crossing on the label data and the expert knowledge, to obtain a data representation and a rule representation; purifying the data representation based on the rule representation; and training and outputting the risk control model based on the purified data representation.

In one or more other embodiments of the present disclosure, the multi-order feature crossing includes first-order feature crossing, second-order feature crossing, and high-order feature crossing.

In one or more other embodiments of the present disclosure, separately performing the multi-order feature crossing on the label data and the expert knowledge is implemented by using a data encoder and a rule encoder.

In one or more other embodiments of the present disclosure, purifying the data representation based on the rule representation further includes: purifying the data representation by using a decision block including a plurality of expert blocks.

In one or more other embodiments of the present disclosure, purifying the data representation based on the rule representation includes: introducing a rule-related loss function based on the rule representation.

In one or more other embodiments of the present disclosure, purifying the data representation based on the rule representation includes: constructing a fusion loss function of a rule-related loss function and a task-related loss function.

In one or more other embodiments of the present disclosure, the label data is black and white label data.

In one or more other embodiments of the present disclosure, a multilayer perceptron (MLP) is used for the first-order feature crossing, a factorization machine (FM) is used for the second-order feature crossing, and a logarithmic neural network (LNN) is used for the high-order feature crossing.

In one or more other embodiments of the present disclosure, purifying the data representation by using the decision block including the plurality of expert blocks is implemented by using expert blocks with different weights.

In one or more other embodiments of the present disclosure, training the risk control model based on the purified data representation includes: optimizing the constructed fusion loss function.

In one or more embodiments of the present disclosure, a knowledge representation learning-based fusion training system for a risk control model is provided, including: an information obtaining module, configured to: receive label data, and refine expert knowledge; a feature crossing module, configured to separately perform multi-order feature crossing on the label data and the expert knowledge, to obtain a data representation and a rule representation; a purification module, configured to: purify the data representation based on the rule representation; and training and output the risk control model based on the purified data representation.

An implementation of the present disclosure provides a computer-readable storage medium storing instructions. When these instructions are executed, a machine is enabled to perform the method described above.

This overview is provided to introduce in a simplified form some concepts that are further described below in the detailed description. This overview is not intended to identify key features or essential features of the claimed subject matter, or intended to limit the scope of the claimed subject matter.

### BRIEF DESCRIPTION OF DRAWINGS

The above inventive content and the following specific implementations of the present disclosure are better understood when read with reference to the accompanying drawings. It should be noted that the accompanying drawings are merely used as examples of the claimed invention. In the accompanying drawings, the same reference numerals represent the same or similar elements.

FIG. 1 is a flowchart of a knowledge representation learning-based fusion training method for a risk control model according to one or more embodiments of the present disclosure;

FIG. 2 is a schematic diagram of a knowledge representation learning-based fusion training framework according to one or more embodiments of the present disclosure;

FIG. 3 is a schematic diagram of a multi-order feature crossing process of label data and expert knowledge of a risk control model according to one or more embodiments of the present disclosure;

FIG. 4 is a schematic diagram of a feature crossing implementation framework in a risk control scenario according to one or more embodiments of the present disclosure;

FIG. 5 is a schematic diagram of a data purification and model training process in knowledge representation learning-based fusion training for a risk control model according to one or more embodiments of the present disclosure; and

FIG. 6 is a block diagram of a knowledge representation learning-based fusion training system for a risk control model according to one or more embodiments of the present disclosure.

### DESCRIPTION OF EMBODIMENTS

To make the above objects, characteristics, and technical benefits of the present disclosure clearer and easier to understand, the following describes specific implementations of the present disclosure in detail with reference to the accompanying drawings.

Many specific details are described in the following description to facilitate full understanding of the present disclosure. However, the present disclosure can be implemented in another manner different from that described here. Therefore, the present disclosure is not limited to the specific implementations disclosed below.

In a current electronic payment environment, transaction events usually include risks. A credible risk control aims to find out risk-free pure white traffic for quick release, to reduce disturbance to users, and reduce computing resources of a system. An omni-trust aims to quickly release all risk-free pure white traffic (for example, account theft).

A conventional trusted model performs modeling based on pre-defined black and white samples. Black samples come from handling of payment events complained by users, and then, events with confirmed involvement are selected as black samples. White samples come from events that the users pay successfully and risk control actions such as complaints, audits, and control are not involved. The white samples are sometimes further processed. For example, a plurality of successful transactions are performed in a short period of time in a user active-passive party relationship dimension. However, this does not deviate from a task of a comparison with black samples produced based on complaint determination.

Usually, robustness is insufficient if trusted model training is directly performed based on black and white label data. A reason is as follows: inconsistent risk concentrations exist in different risk domains. A risk control system can intercept most risk transactions in an earlier built risk domain. Consequently, a magnitude of risk events that are finally exposed in complaint samples is insufficient to support a training process of the trusted model. For example, a quantity of risk event samples exposed outside per month in a specific risk domain is less than 100. Compared with millions of white samples, such black samples are very likely to be insufficient to feed back a full picture of a risk event. That is, insufficient black samples lead to insufficient robustness of the risk control trusted model.

Robustness is an important evaluation indicator of a machine learning model, and is mainly used to check whether the model can still maintain determining accuracy in a case of a slight change in input data, that is, whether the model performs stably in a case of a specific change. The robustness directly determines a generalization capability of the machine learning model.

In addition, in a risk control scenario, a conventional neural network training manner does not satisfy a model interpretable requirement of a trusted service. A training process of a neural network is a black box and lacks guidance. A final result is available in a statistical sense, but may not satisfy an interpretable requirement in terms of a single example. For example, relatively strong expert experience is that longer duration between a current time (a recency type feature) and the first use time of a user and a device indicates a more trusted device. However, dirty read (R=30) of a single example of a black sample in data samples results in distortion of a finally trained model in such a type of feature, and a local abnormality interval occurs.

In view of this, the present disclosure provides a knowledge representation learning-based fusion training solution for a risk control model. Based on precipitation of expert experience in the risk control field, and by introducing multi-order feature crossing and data purification, robustness of the risk control model is improved, and interpretation of the risk control model satisfies a requirement.

In the present disclosure, specific descriptions of the solution are mainly provided by using electronic payment risk control as an example. A person skilled in the art can understand that a knowledge representation learning-based fusion training solution for a risk control model in the present disclosure is applicable to various types of risk control models, and is not limited to an electronic payment risk control model.

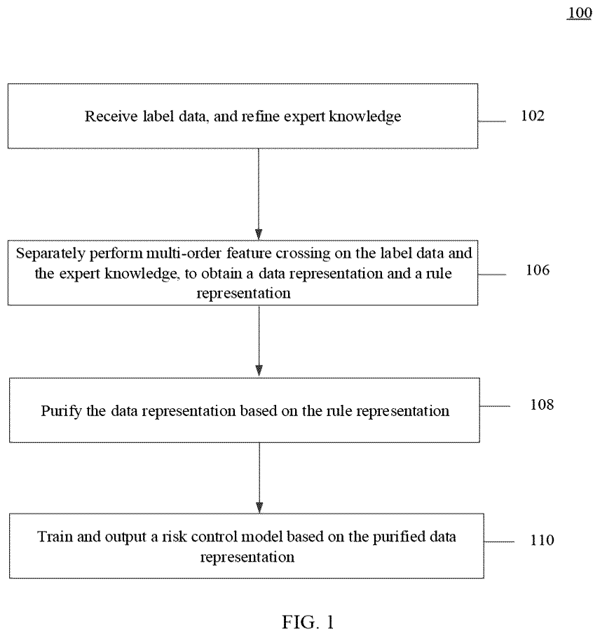

FIG. 1 is a flowchart of a knowledge representation learning-based fusion training method 100 for a risk control model according to one or more embodiments of the present disclosure.

For a credible risk control, there are two conventional manners: a manner based on a trusted manual policy and a manner of training a trusted model based on black and white samples. In the manner based on a trusted manual policy, trusted release in an initial phase in a risk control system depends on a manual policy. For example, if duration between a current time and the first use of a user and a device is greater than 30 days, a quantity of use days is greater than 30 days, and a cumulative amount exceeds 200 yuan, it is determined that the device is a trusted device, and trusted release is granted in terms of whether the device is stolen. Based on a manual rule, a relative granularity is relatively coarse, and precision and a recall rate are relatively low.

In the manner of training the trusted model based on the black and white samples, each transaction event is scored by using a real-time model, and trusted release is granted if a score of a trusted model is high. However, because there are insufficient black samples, robustness of the trusted model is insufficient, and a conventional neural network training manner cannot satisfy a model interpretable requirement of a trusted service.

Knowledge representation learning is used to learn of distributed representations of entities and relationships. On the basis of selecting proper representation space, the entities and the relationships are represented by using a proper triplet, and relationship interaction is modeled by using a corresponding coding model. In the present disclosure, for knowledge representation learning for expert knowledge, the expert knowledge is introduced in a modeling process of a risk control trusted model to assist in training, to improve robustness of the risk control trusted model and make the risk control trusted model interpretable.

102: Receive label data, and refine expert knowledge.

Step 102 is a preparation for training data, that is, black and white label data and rule refining based on the expert knowledge. The black and white label data are prepared in a conventional manner: Based on a transaction event sample, black and white labels are marked based on a result of user complaints and trial determination.

The expert knowledge is used to assist in training and purify the label data, to reduce a part that is of a result output by the model and that is different from a meaning precipitated in a risk control scenario, and improve the robustness of the trusted model.

106: Separately perform multi-order feature crossing on the label data and the expert knowledge, to obtain a data representation and a rule representation.

For a multi-dimensional input feature dataset, nonlinear feature fitting can be performed for feature crossing, to improve a nonlinear modeling capability of the model, and further improve model performance. However, in the risk control trusted model, there are a plurality of dimensions of features, and various features have relatively large different importance. That is, these features are non-homogeneous. Therefore, multi-order feature crossing is introduced for different types and dimensions of features, to facilitate performance improvement of the risk control trusted model.

The expert knowledge is introduced because a large amount of expert experience is precipitated in the risk control field. In addition, an attack and a defense exist in the risk control field, and the samples have a very fast change rhythm, so that a data distribution of the model fluctuates greatly. The risk control trusted model is constructed and trained by adding the expert knowledge, instead of just using the label data, to help purify the label data and remove a fluctuation in an abnormal value in a small quantity of black samples.

Therefore, in the present disclosure, multi-order feature crossing is also performed for the introduced expert knowledge, to obtain both the data representation and the rule representation.

Separately performing the multi-order feature crossing on the label data and the expert knowledge is implemented by using a data encoder and a rule encoder. The multi-order feature crossing includes first-order feature crossing, second-order feature crossing, and high-order feature crossing (≥three orders, which is briefly referred to as 3+-order). In different application scenarios, feature crossing of different orders can be performed based on a requirement.

In one or more other embodiments of the present disclosure, a multilayer perceptron (MLP) is used for the first-order feature crossing, a factorization machine (FM) is used for the second-order feature crossing, and a logarithmic neural network (LNN) is used for the high-order feature crossing.

It can be understood by a person skilled in the art that both the multilayer perceptron (MLP) and the factorization machine (FM) can be applied to first-order feature crossing or second-order feature crossing, and third-order feature crossing and a higher-order feature crossing can be deep crossing DeepCross, a high-order factorization machine (HOFM), the deepest factorization machine (xDeepFM), the deformable convolution machine DCN-V2, etc. Further, the above-mentioned mechanisms are not limited, and a new feature crossing mechanism can also be incorporated into the technical solutions of the present disclosure.

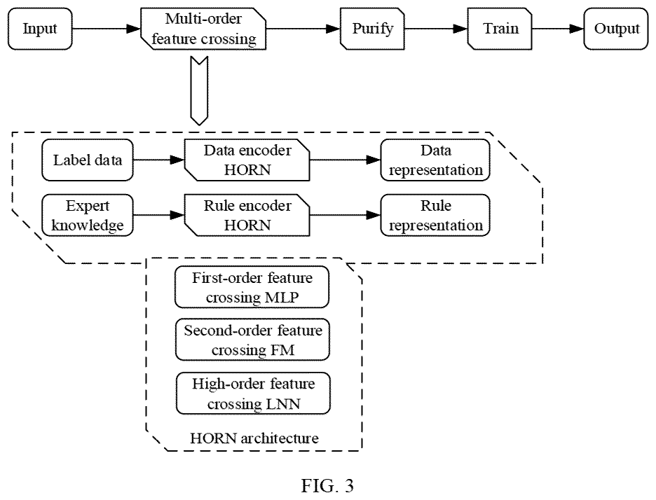

The following describes in detail a feature crossing implementation framework in a risk control scenario according to one or more embodiments of the present disclosure with reference to FIG. 3.

108: Purify the data representation based on the rule representation.

As described above, an attack and a defense exist in the risk control field, and the samples have a very fast change rhythm, so that a data distribution of the model fluctuates greatly. Therefore, the label data needs to be purified, so that a fluctuation in a model data distribution is effectively controlled, so that purified information is relatively static, to further improve robustness of the model.

In one or more other embodiments of the present disclosure, purifying the data representation based on the rule representation further includes: purifying the data representation by using a decision block including a plurality of expert blocks. Purifying the data representation by using the decision block including the plurality of expert blocks can be implemented by using expert blocks with different weights.

Certainly, a person skilled in the art can understand that, in different application scenarios, a quantity of expert blocks can be used based on a requirement, and weights of the expert blocks can also be set or changed based on a requirement.

In one or more other embodiments of the present disclosure, purifying the data representation based on the rule representation includes: introducing a rule-related loss function based on the rule representation. Subsequently, a fusion loss function of a rule-related loss function and a task-related loss function is constructed.

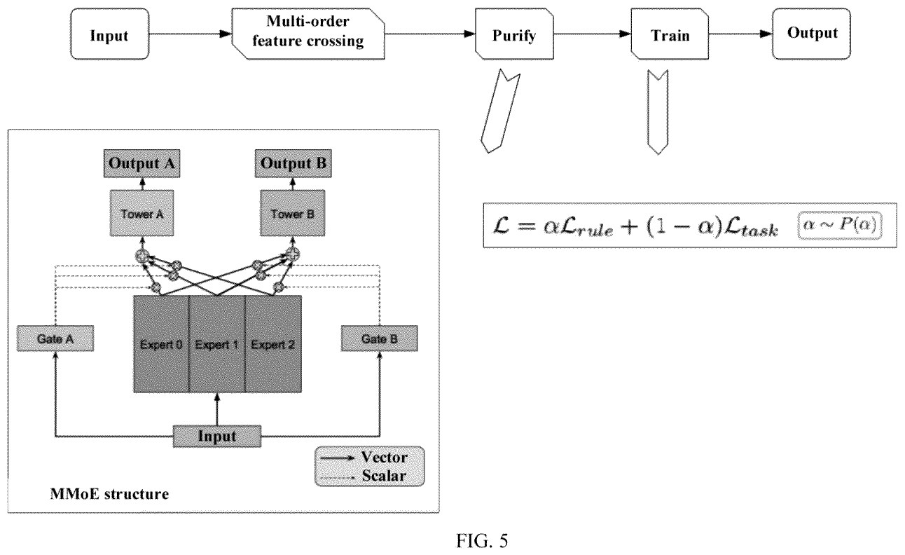

The following describes in detail, with reference to FIG. 5, a data purification and model training process in knowledge representation learning-based fusion training for a risk control model according to one or more embodiments of the present disclosure.

110: Train and output a risk control model based on the purified data representation.

In one or more other embodiments of the present disclosure, training the risk control model based on the purified data representation includes: optimizing the constructed fusion loss function. When the fusion loss function is optimal, the trained risk control model is output. The trained risk control model can go online for running.

In view of this, in the knowledge representation learning-based fusion training method for a risk control model in the present disclosure, based on precipitation of expert experience in the risk control field, and by introducing multi-order feature crossing and data purification, robustness of the risk control model is improved, and interpretation of the risk control model satisfies a requirement.

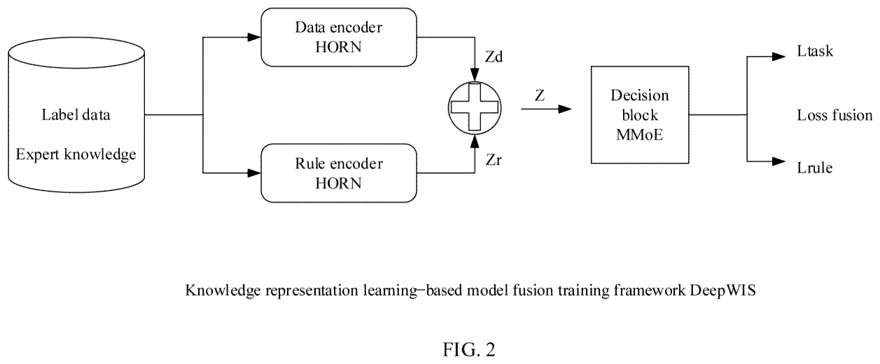

FIG. 2 is a schematic diagram of a knowledge representation learning based fusion training framework according to one or more embodiments of the present disclosure.

As shown in FIG. 2, the present disclosure discloses a knowledge representation learning-based model fusion training framework deep learning based trust recognition architecture with the mixture of expert wisdom (DeepWIS).

The DeepWIS framework in the present disclosure is based on a deep neural network with controllable rule representation (DeepCTRL), but a rule encoder and a data encoder perform multi-order feature crossing by using a high-order networks (HORN) structure, and combinations of different quantities or weights of expert blocks are used as decision blocks for different tasks.

Specifically, as shown in FIG. 2, the DeepWIS framework in the present disclosure is based on underlying features of a label data set and the refined expert knowledge. Then, the two encoders perform processing, and are respectively a rule encoder and a data encoder that are in a form of the HORN. A feature passes through the two coding layers in parallel, to perform high-dimensional feature crossing, which are respectively first-order feature crossing, second-order feature crossing, and high-order feature crossing (that is, third-order feature crossing and high-order feature crossing).

After encoding, the rule encoder and the data encoder respectively generate two representation vectors Z, (rule representation) and Za (data representation). The two representation vectors are weighted and a concatenation (concat) operation is performed, to form a vector z:

$$z = α {z}_{r} ⊕ ( 1 - α ) {z}_{d} .$$

A value of α is not fixed, but is randomly sampled from distribution that satisfies α−P(α) in a training process, to improve generalization performance of a model between a label task and a knowledge task.

In one or more other embodiments of the present disclosure, a P(α) distribution can be replaced by a Beta(β, β) distribution, and the concatenation (concat) operation can be replaced by a vector-by-vector addition operation.

The vector z is followed by the decision block, and a form can be a simple MLP, or can be another form, for example, a mixture-of-experts (MoE).

Then, a loss Lᵣᵤₗₑ (for example, the rule-related loss function) of the expert knowledge and a loss Lₜₐₛₖ (for example, the task-related loss function) of the risk task are separately calculated. Weights of the loss Lᵣᵤₗₑ and the loss Lₜₐₛₖ are adjusted by using the above-mentioned variable α:

$$ℒ = {αℒ}_{rule} + ( 1 - α ) {ℒ}_{task} .$$

The expert knowledge loss or the rule loss Lᵣᵤₗₑ is introduced, so that the purified information is relatively static, to improve the robustness of the model. For different risk control scenarios, Lᵣᵤₗₑ can be set based on a requirement, and Lᵣᵤₗₑ can also be fused with Lₜₐₛₖ based on a requirement.

In one or more embodiments of the present disclosure, to balance dimensions of Lᵣᵤₗₑ and Lₜₐₛₖ, an initial loss ratio ρ=Lᵣᵤₗₑ,0/Lₜₐₛₖ,0 is calculated, and then the fusion loss function of the rule-related loss function and the task-related loss function is constructed:

$$ℒ = {E}_{α ∼ P ( α )} [ {αℒ}_{rule} + ρ ( 1 - α ) {ℒ}_{task} ] .$$

The risk control trusted model is trained in the DeepWIS framework, and is optimized for a final weighted target L. After training is converged, a model file obtained after training is completed is generated for subsequent online scoring and invoking.

FIG. 3 is a schematic diagram of a multi-order feature crossing process of label data and expert knowledge of a risk control model according to one or more embodiments of the present disclosure.

As shown in FIG. 3, a multi-order feature crossing process of label data and expert knowledge of a risk control model according to one or more embodiments of the present disclosure is performed by using a data encoder and a rule encoder that are in a form of a HORN. Multi-order feature crossing is performed on the label data and the expert knowledge in parallel at two coding layers: a data coding layer and a rule coding layer.

In one or more embodiments of the present disclosure, multi-order feature crossing includes an MLP layer, an FM layer, and an LNN layer, which are respectively used as first-order feature crossing, second-order feature crossing, and ≥third-order feature crossing, as shown in the following formula:

$${f}_{e} ( \tilde{x} ; θ ) := σ ( {w}^{( 1 )} \tilde{x} + \frac{1}{2} [ {( {\sum }_{i = 1}^{{d}_{e}} {w}_{il}^{( 2 )} {\tilde{x}}_{i} )}^{2} - {\sum }_{i = 1}^{{d}_{e}} {( {w}_{il}^{( 2 )} {\tilde{x}}_{i} )}^{2} ] + {\sum }_{o = 3}^{N} {h}_{o} ( {u}_{o} , \tilde{x} ) ; {w}_{e} , {w}_{e 0} )$$

Here, ( ) represents an activation function, for example, Relu and Sigmoid.

w⁽¹⁾\tilde{x} represents an MLP layer, first-order feature crossing is performed, w⁽¹⁾ is a parameter of the MLP layer, and \tilde{x} represents that outputs of an embedding layer are concatenated.

$$\frac{1}{2} [ {( {\sum }_{i = 1}^{{d}_{e}} {w}_{il}^{( 2 )} {\tilde{x}}_{i} )}^{2} - {\sum }_{i = 1}^{{d}_{e}} {( {w}_{il}^{( 2 )} {\tilde{x}}_{i} )}^{2} ]$$

represents a factorization machine (FM) layer, and second-order feature crossing is performed. de represents a quantity of fields.

$${w}_{il}^{( 2 )}$$

represents the parameter of the FM. \tilde{x}ᵢ represents an embedded output of the i^{th} field at the embedding layer.

$${\sum }_{O = 3}^{N} {h}_{0} ( {u}_{0} , \tilde{x} ) ; {w}_{e} ; {w}_{e 0}$$

represents a logarithmic neural network (LNN) layer, and third-order and high-order feature crossing are performed. h₀(u₀,\tilde{x})=exp(u₀ ln \tilde{x}) o represents a quantity of orders of feature crossing, starting from 3. \tilde{x}ᵢ represents the embedded output of the i^{th} field at the embedding layer. u₀; wₑ; wₑ₀ is the parameter of the LNN.

As described above, it can be understood by a person skilled in the art that both the multilayer perceptron (MLP) and the factorization machine (FM) can be applied to first-order feature crossing or second-order feature crossing, and third-order feature crossing and a higher-order feature crossing can be deep crossing DeepCross, a high-order factorization machine (HOFM), the deepest factorization machine (xDeepFM), the deformable convolution machine DCN-V2, etc. Similarly, the listed third-order feature crossing and higher-order feature crossing can alternatively be first-order feature crossing or second-order feature crossing.

Further, the above-mentioned mechanisms are not limited, and a new feature crossing mechanism can also be incorporated into the technical solutions of the present disclosure. A person skilled in the art can understand that different cross-feature mechanisms can be used in different application scenarios.

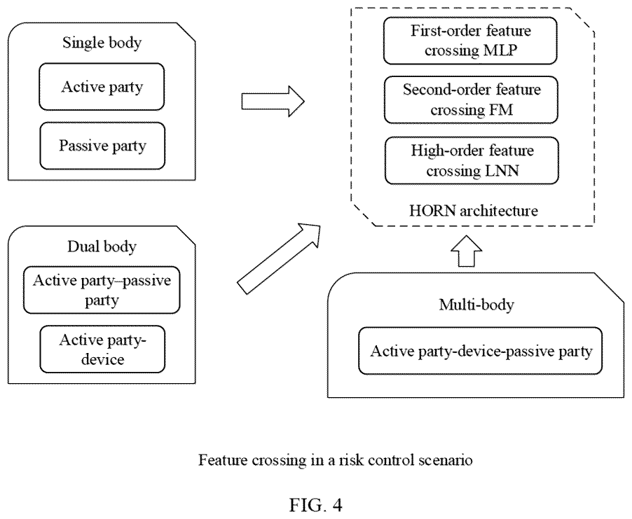

FIG. 4 is a schematic diagram of a feature crossing implementation framework in a risk control scenario according to one or more embodiments of the present disclosure.

As shown in FIG. 4, in a risk control trusted service scenario, feature patterns usually include a single body (for example, a feature of an active party dimension, a feature of a passive party dimension), a dual body (for example, an active party-passive party dimension, or an active party-device dimension), a multi-body (for example, an active party-device-passive party), etc.

In the knowledge representation learning-based fusion training solution for a risk control model in the present disclosure, the framework is implemented through feature crossing, a maximum of dual body needs to be designed for a manual feature project, and the framework is automatically completed by using high-order crossing as feature crossing. For example, for three features of the dual body “a proportion of a current transaction of the active party to transactions in the past seven days, an average transaction amount of the active party and the passive party within seven days, and a proportion of complained transactions of the passive party within 90 days”, high-order semantics of “the probability that an account in which a current transaction amount has 3 times of mutation is at risk in a strange account whose proportion of complaints is higher than 20%” can be automatically obtained through fitting.

Compared with the common multilayer perceptron (MLP), models that distinguish the first-order feature crossing, the second-order feature crossing, and the 3+-order feature crossing are applied to improve an effect, because a feature of the risk control application scenario differs from a task such as a text, an image, and voice in that importance of the feature is not an average value. For the image, all pixels are homogeneous. Features in the risk control field are heterogeneous.

For example, a feature in the risk control field includes a velocity feature (fast) such as an “a maximum value of a model score of the passive party account in an identification model in the last seven days”. There is fast data growth, fast processing, and high time efficiency. In experience, a better effect can be achieved based on this type of feature usually through first-order semantics, and higher-order crossing sometimes buries semantics of the feature.

For another example, features such as “a total value of transaction amounts in the past 90 days of an account” often require ≥3-order (that is, 3+-order) feature crossing to play an important role.

Therefore, in the knowledge representation learning-based fusion training solution for a risk control model in the present disclosure, first-order feature crossing, second-order feature crossing, and 3+-order feature crossing used in the feature crossing implementation framework has a relatively good harmony effect on all types of features.

FIG. 5 is a schematic diagram of a data purification and model training process in knowledge representation learning-based fusion training for a risk control model according to one or more embodiments of the present disclosure.

In the knowledge representation learning-based fusion training solution for a risk control model in the present disclosure, data purification is implemented in the decision block. As described above, a form of the decision block can be a simple MLP, or can be another form, such as a mixture-of-experts (MoE).

In one or more embodiments of the present disclosure, the decision block is implemented as a multi-gate mixture-of-experts (MMoE) layer. In an MMoE structure used in the multi-task network structure, an n-expert (Expert) module simulates n experts to perform scoring, and uses a gate mechanism to control a weight of each expert for each task, as shown in the following formula:

$${y}_{k} = {h}^{k} ( {f}^{k} ( x ) ) , {f}^{k} ( x ) = {\sum }_{i = 1}^{n} {{g}^{k} ( x )}_{i} {f}_{i} ( x )$$

x is an output of the concatenation layer, k represents k tasks, and n represents n expert networks.

For different tasks, an output of a specific gate represents a probability that different experts are selected, and weighted summarization is performed on the plurality of experts. g(x) represents an output of the gate, g^{k}(x)ᵢ represents a weight of the k^{th} task on the gate of the i^{th} expert, and multiplies a score fᵢ(x) of the i^{th} expert. h^{k} is a tower, is used to obtain information unique to each task, and is usually a linear transformation plus a Softmax layer.

g(x) represents the output of the gate. The multilayer perceptron model is used to implement linear transformation plus Softmax layer.

Here, different from a conventional multi-task MoE structure, a final yₖ is output as a value, that is, degraded to a multi-label task.

By introducing a plurality of experts into the decision block, the rapidly changing data features in the risk control field are purified, and abnormal values in a small amount of black samples do not affect the final model decisively.

Further, a loss function Lᵣᵤₗₑ of expert experience embodied by the rule encoder is introduced in the risk control trusted model.

The conventional model is not robust because the black sample in the risk control field is not absolute. The black sample is manually determined, and a certain error exists. In addition, a case audited by an existing system becomes a hidden case. In addition, an attack and a defense exist in the field of risk control, so that a change rhythm of the black sample is very fast.

After the Loss (loss) is improved by adding the rules output based on the expert experience, this type of purified information is relatively static. Therefore, the data distribution of the control model can be effectively controlled, to avoid a relatively large fluctuation.

$$ℒ = {αℒ}_{rule} + ( 1 - α ) {ℒ}_{task}$$

The weights of Lₜₐₛₖ and Lᵣᵤₗₑ are still a to guide the rule encoder and the data encoder to separately learn of respective corresponding semantics.

Specifically, a loss Lₜₐₛₖ of a risk task is the same as that of a conventional task. When the plurality of risk tasks exist, weighted summarization needs to be performed first:

$${L}_{task} = {m}_{1} {L}_{task 1} + {m}_{2} {L}_{task 2} + … + {m}_{n} {L}_{taskn}$$

As described above, in one or more embodiments of the present disclosure, in order to balance dimensions of Lᵣᵤₗₑ and Lₜₐₛₖ, the initial loss ratio ρ=Lᵣᵤₗₑ,0/Lₜₐₛₖ,0 is first calculated, and then a rule-related loss function and a task-related loss function fusion loss function are constructed:

$$ℒ = {E}_{α ∼ P ( α )} [ {αℒ}_{rule} + ρ ( 1 - α ) {ℒ}_{task} ]$$

For example, when it is determined whether a current transaction involves a device at risk of theft is in trusted semantics, the first successful transaction between an account and a device has a strong positive correlation with a trust, and a threshold is seven days, representing an average reporting period of a user. However, in a model training process, an output result of the model fluctuates due to impact of an extreme value of dirty read, which does not conform to expert cognition.

In a sense, a piece of expert knowledge can be extracted: “The duration between the current time and the first use of the device exceeds seven days, and compared with a case in which the duration is less than seven days, the device is semantically credible in terms of theft”.

The input feature vector is denoted as x. The feature is xₖ. A smaller offset δ is introduced, and then xₚ=x+δx. If the output items of the model before and after the offset is added are denoted as yⱼ and y_{p,j}, the loss item of the knowledge represented by the above-mentioned semantics is as follows:

$${ℒ}_{rule} ( x , {x}_{p} , {\hat{y}}_{j} , {\hat{y}}_{p , j} ) = ReLU ( {\hat{y}}_{j} - {\hat{y}}_{p , j} ) \cdot I ( {x}_{k} < a ) \cdot I ( {x}_{p , k} > a )$$

Here, a=7. The expression means that punishment is imposed when xₖ and xₚ are sorted on both sides of the threshold 7, and a model score when the duration between the current time and the first use of the device exceeds seven days is less incredible than that in a case in which the duration is less than seven days.

When a plurality of pieces of expert knowledge exist, weighted summarization needs to be performed first:

$${L}_{rule} = {q}_{1} {L}_{rule 1} + {q}_{2} {L}_{rule 2} + … + {q}_{n} {L}_{rulen}$$

During model training, the final weighted target L is optimized. After training is converged, the model file after the training is completed is generated for subsequent online scoring and invoking.

Therefore, in a data purification and training process in the present disclosure, a problem of model robustness in the risk control field is resolved based on precipitation of a relatively large amount of expert experience in the risk control field, and a requirement for interpretability in the risk control field is further satisfied.

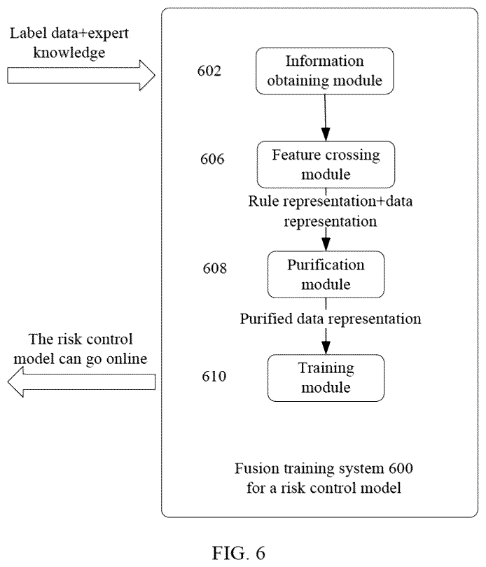

FIG. 6 is a block diagram of a knowledge representation learning-based fusion training system 600 for a risk control model according to one or more embodiments of the present disclosure.

The knowledge representation learning-based fusion training system 600 for a risk control model according to one or more embodiments of the present disclosure includes an information obtaining module 602, a feature crossing module 606, a purification module 608, and a training module 610.

The information obtaining module 602 is configured to: receive label data, and refine expert knowledge.

The information obtaining module 602 prepares for training data, that is, black and white label data and rule refining based on the expert knowledge. The black and white label data are prepared in a conventional manner: Based on a transaction event sample, black and white labels are marked based on a result of user complaints and trial determination. The expert knowledge is used to assist in training and purify the label data, to reduce a part that is of a result output by the model and that is different from a meaning precipitated in a risk control scenario, and improve the robustness of the trusted model.

The feature crossing module 606 is configured to: separately perform multi-order feature crossing on the label data and the expert knowledge, to obtain a data representation and a rule representation.

For a multi-dimensional input feature dataset, nonlinear feature fitting can be performed for feature crossing, to improve a nonlinear modeling capability of the model, and further improve model performance. However, in the risk control trusted model, there are a plurality of dimensions of features, and various features have relatively large different importance. That is, these features are non-homogeneous. Therefore, multi-order feature crossing is introduced for different types and dimensions of features, to facilitate performance improvement of the risk control trusted model.

The expert knowledge is introduced because a large amount of expert experience is precipitated in the risk control field. In addition, an attack and a defense exist in the risk control field, and the samples have a very fast change rhythm, so that a data distribution of the model fluctuates greatly. The risk control trusted model is constructed and trained by adding the expert knowledge, instead of just using the label data, to help purify the label data and remove a fluctuation in an abnormal value in a small quantity of black samples.

Therefore, in the present disclosure, multi-order feature crossing is also performed for the introduced expert knowledge, to obtain both the data representation and the rule representation.

Separately performing the multi-order feature crossing on the label data and the expert knowledge is implemented by using a data encoder and a rule encoder. The multi-order feature crossing includes first-order feature crossing, second-order feature crossing, and high-order feature crossing (≥three orders, which is briefly referred to as 3+-order). In different application scenarios, feature crossing of different orders can be performed based on a requirement.

The purification module 608 purifies the data representation based on the rule representation.

As described above, an attack and a defense exist in the risk control field, and the samples have a very fast change rhythm, so that a data distribution of the model fluctuates greatly. Therefore, the label data needs to be purified, so that a fluctuation in a model data distribution is effectively controlled, so that purified information is relatively static, to further improve robustness of the model.

That the purification module 608 purifies the data representation based on the rule representation can include: The purification module 608 purifies the data representation by using a decision block including a plurality of expert blocks. Purifying the data representation by using the decision block including the plurality of expert blocks can be implemented by using expert blocks with different weights.

Certainly, a person skilled in the art can understand that, in different application scenarios, a quantity of expert blocks can be used based on a requirement, and weights of the expert blocks can also be set or changed based on a requirement.

That the purification module 608 purifies the data representation based on the rule representation can further include: The purification module 608 introduces a rule-related loss function based on the rule representation. Subsequently, the purification module 608 constructs a fusion loss function of a rule-related loss function and a task-related loss function.

The training module 610 is configured to train and output the risk control model based on the purified data representation.

That the training module 610 trains the risk control model based on the purified data representation includes: The training module 610 optimizes the constructed fusion loss function. When the fusion loss function is optimal, the training module 610 outputs the trained risk control model. The trained risk control model can go online for running.

In view of this, in the knowledge representation learning-based fusion training system for a risk control model in the present disclosure, based on precipitation of expert experience in the risk control field, and by introducing multi-order feature crossing and data purification, robustness of the risk control model is improved, and interpretation of the risk control model satisfies a requirement.

The steps and modules in the knowledge representation learning-based fusion training method and system for a risk control model can be implemented by hardware, software, or a combination thereof. If implemented in hardware, various illustrative steps, modules, and circuits described with reference to the present invention can be implemented or performed by a general-purpose processor, a digital signal processor (DSP), an application-specific integrated circuit (ASIC), a field programmable gate array (FPGA) or another programmable logic component, a hardware component, or any combination thereof. The general-purpose processor can be a processor, a microprocessor, a controller, a microcontroller, a state machine, etc. If implemented in software, various illustrative steps and modules described with reference to the present invention can be stored or transmitted as one or more instructions or code on a computer-readable medium. A software module that implements various operations in the present invention can reside in a storage medium, such as a RAM, a flash memory, a ROM, an EPROM, an EEPROM, a register, a hard disk, a removable disk, a CD-ROM, or a cloud storage. The storage medium can be coupled to a processor, so that the processor can read information from the storage medium/write information into the storage medium, and execute corresponding program modules to implement the steps in the present invention. In addition, software-based implementations can be uploaded, downloaded, or remotely accessed through an appropriate communication means. The appropriate communication means includes, for example, the Internet, the World Wide Web, the Intranet, software applications, cables (including optical fiber cables), magnetic communication, electromagnetic communication (including RF, microwave, and infrared communication), electronic communication, or other such communication means.

It should be further noted that these implementations can be described as processes depicted as flowcharts, flow diagrams, structural diagrams, or block diagrams. Although the flowcharts can describe the operations as sequential processes, many of these operations can be performed in parallel or concurrently. In addition, an order of these operations can be rearranged.

The disclosed methods, apparatuses, and systems shall not be limited in any way. In contrast, the present invention covers all novel and non-obvious features and aspects of various disclosed implementations (individual implementations and various combinations and sub-combinations of the implementations). The disclosed methods, apparatuses, and systems are not limited to any specific aspect or feature or combination thereof, and any disclosed implementation does not need to have any one or more specific advantages or resolve specific or all technical problems.

The implementations of the present invention are described above with reference to the accompanying drawings. However, the present invention is not limited to the above specific implementations. The above specific implementations are merely examples and are not intended for limitation. Under inspiration of the present invention, a person of ordinary skill in the art can make many changes without departing from the spirit of the present invention and the scope protected by the claims, and these changes all fall within the protection scope of the present invention.

1. A fusion training method for a risk control model, comprising:
receiving label data, and refining expert knowledge;
separately performing multi-order feature crossing on the label data and the expert knowledge, to obtain a data representation and a rule representation;
purifying the data representation based on the rule representation; and
training and outputting the risk control model based on the purified data representation.

2. The method according to claim 1, wherein the multi-order feature crossing comprises first-order feature crossing, second-order feature crossing, and high-order feature crossing.

3. The method according to claim 1, wherein separately performing the multi-order feature crossing on the label data and the expert knowledge is implemented by using a data encoder and a rule encoder.

4. The method according to claim 1, wherein purifying the data representation based on the rule representation further comprises: purifying the data representation by using a decision block comprising a plurality of expert blocks.

5. The method according to claim 1, wherein purifying the data representation based on the rule representation comprises: introducing a rule-related loss function based on the rule representation.

6. The method according to claim 1, wherein purifying the data representation based on the rule representation comprises: constructing a fusion loss function of a rule-related loss function and a task-related loss function.

7. The method according to claim 1, wherein the label data are black and white label data.

8. The method according to claim 2, wherein a multilayer perceptron (MLP) is used for the first-order feature crossing, a factorization machine (FM) is used for the second-order feature crossing, and a logarithmic neural network (LNN) is used for the high-order feature crossing.

9. The method according to claim 4, wherein purifying the data representation by using the decision block comprising the plurality of expert blocks is implemented by using expert blocks with different weights.

10. The method according to claim 6, wherein training the risk control model based on the purified data representation comprises: optimizing the constructed fusion loss function.

11. (canceled)

12. A non-transitory computer-readable storage medium, wherein the non-transitory computer-readable storage medium stores a computer program, which when executed by a processor causes the processor to:
receive label data, and refine expert knowledge;
separately perform multi-order feature crossing on the label data and the expert knowledge, to obtain a data representation and a rule representation;
purify the data representation based on the rule representation; and
train and output the risk control model based on the purified data representation.

13. A computing device, comprising a memory, a processor, and a computer program that is stored in the memory and that is capable of running on the processor, wherein when the processor executes the program, the computing device is caused to:
receive label data, and refine expert knowledge;
separately perform multi-order feature crossing on the label data and the expert knowledge, to obtain a data representation and a rule representation;
purify the data representation based on the rule representation; and
train and output the risk control model based on the purified data representation.

14. The computing device according to claim 13, wherein the multi-order feature crossing comprises first-order feature crossing, second-order feature crossing, and high-order feature crossing.

15. The computing device according to claim 13, wherein the computing device being caused to separately perform the multi-order feature crossing on the label data and the expert knowledge is implemented by using a data encoder and a rule encoder.

16. The computing device according to claim 13, wherein the computing device being caused to purify the data representation based on the rule representation further comprises being caused to: purify the data representation by using a decision block comprising a plurality of expert blocks.

17. The computing device according to claim 13, wherein the computing device being caused to purify the data representation based on the rule representation comprises being caused to: introduce a rule-related loss function based on the rule representation.

18. The computing device according to claim 13, wherein the computing device being caused to purify the data representation based on the rule representation comprises being caused to: construct a fusion loss function of a rule-related loss function and a task-related loss function.

19. The computing device according to claim 13, wherein the label data are black and white label data.

20. The computing device according to claim 14, wherein a multilayer perceptron (MLP) is used for the first-order feature crossing, a factorization machine (FM) is used for the second-order feature crossing, and a logarithmic neural network (LNN) is used for the high-order feature crossing.

21. The computing device according to claim 16, wherein the computing device being caused to purify the data representation by using the decision block comprising the plurality of expert blocks is implemented by using expert blocks with different weights.
